(19) United States
(12) Patent Application Publication
(10) Pub. No.: US 2010/0143730 A1
(43) Pub. Date: Jun. 10, 2010

(54) Plated Resin Molded Article

(76) Inventor: Toshihiro Tai, Hyogo (JP)

Correspondence Address: FLYNN THIEL BOUTELL & TANIS, P.C., 2026 RAMBLING ROAD, KALAMAZOO, MI, 49008-1631, US

(21) Appl. No.: 12/308,609

(22) PCT Filed: Aug. 2, 2007
(86) PCT No.: PCT/JP2007/065568

§ 371 Date: Dec. 18, 2008

(30) Foreign Application Priority Data
Aug. 4, 2006 (JP) 2006-213256
Mar. 29, 2007 (JP) 2007-088169

(51) Int. Cl. B32B 15/08; B05D 1/18

(52) U.S. Cl. 428/458; 427/430.1

(57) ABSTRACT

The present invention provides a plated resin molded article having high heat resistance and plating adhesive strength, and further having beautiful appearance. Specifically it provides the plated resin molded article having a metallic plating layer on the surface thereof, composed of: a resin composition containing (A) a synthetic resin, (B) a water-soluble substance having a solubility in water (at 25° C.) ranging from 0.01/100 g to 10 g/100 g, and (C) a polymer having a maleimide-based monomer unit, wherein the resin molded article is not treated by etching by an acid containing chromium and/or manganese.

### TECHNICAL FIELD

The present invention relates to a plated resin molded article which has high heat resistance and plating strength, and has a beautiful appearance.

### BACKGROUND ARTS

Resin molded articles such as ABS resins or polyamide resins are used as automobile parts in order to reduce the weight of automobile bodies. To provide these resin molded articles with a luxurious and beautiful appearance, plating with copper, nickel, and the like is applied thereon.

Conventionally, the plating on a molded article such as ABS resin essentially includes an etching process to roughen the surface of a resin molded article after a degreasing process in order to increase adhesive strength between the resin molded article and a plating layer. For example, when an ABS resin molded article or a polypropylene molded article is plated, etching treatment is required after degreasing, using a chromic acid bath (a mixed liquid of chromium trioxide and sulfuric acid) at temperatures ranging from 65° C. to 70° C. for 10 to 15 minutes, and thus the generated wastewater contains toxic hexavalent chromate ions. Consequently, there is indispensable a treatment of reducing the hexavalent chromate ions to trivalent ions, and then neutralizing and precipitating the trivalent chromate ions, which then raises problems in wastewater treatment.

When safety at work at the workplace and the influence of wastewater on the environment are considered, it is preferred not to apply etching using a chromic acid bath. In that case, however, there arises a problem that the adhesive strength of the plating layer to the molded article prepared from ABS resin and the like cannot be attained.

The inventions disclosed in JP-A 2003-82138, JP-A 2003-166067 and JP-A 2004-2996 solved the above-described problems in the conventional technologies, and provided a plated resin molded article having a metallic plating layer with high adhesive strength in spite of the fact that the etching treatment using a chromic acid bath was eliminated.

The invention according to JP-B 6-99630, mixes a large amount of inorganic filler having large particle sizes, (Example uses an inorganic filler having a mean particle size ranging from 2.2 to 12 μm by 40% by weight), in the step of plating a polyamide molding, in order to improve a surface roughening treatment by hydrochloric acid etching and to increase adhesive strength of the metallic plating. The invention further uses a rubber-like substance as a mixing component to suppress the deterioration of impact strength resulting from the addition of the inorganic filler.

### DISCLOSURE OF THE INVENTION

The inventions of JP-A 2003-82138, JP-A 2003-166067 and JP-A 2004-2996 are not sufficiently improved in the mold-releasability owing to a low elastic modulus and low solidification speed when the injection molding method is applied as a method for manufacturing the resin molded article before plating. The invention of JP-B 6-99630 is expected to give good mold-releasability during injection molding because of the addition of a large amount of inorganic filler. The invention, however, uses a large amount of inorganic filler and forms irregular surface resulted from removal by dissolving the inorganic filler at the time of acid treatment, which raises a problem of deteriorating an appearance after metallic plating, though the adhesive strength of the metallic plating increases after the plating.

The invention of JP-A 07-157623 discloses the plating of a molded article prepared from a resin composition containing a maleimide-based copolymer. As described in Example in JP-A 7-157623, however, the etching process using chromic acid (CrO₃) is adopted.

The present invention provides a plated resin molded article which has good mold-releasability at the time of the injection molding of resin molded article before the plating process, has high heat resistance and high adhesive strength, and has a beautiful appearance, while etching using chromic acid or the like is not carried out in the manufacturing process.

The present invention provides a plated resin molded article having a metallic plating layer on the surface thereof, composed of: a resin composition containing

(A) a synthetic resin,
(B) a water-soluble substance having a solubility in water (at 25° C.) ranging from 0.01/100 g to 10 g/100 g, and
(C) a polymer having a maleimide-based monomer unit, provided that the resin molded article is not treated by etching by an acid containing chromium and/or manganese.

The present invention provides a method for manufacturing plated resin molded article having a metallic plating layer, including step of applying a metallic plating on the surface of a resin molded article composed of a resin composition containing (A) a synthetic resin, (B) a water-soluble substance having a solubility in water (at 25° C.) ranging from 0.01/100 g to 10 g/100 g, and (C) a polymer having a maleimide-based monomer unit, provided that the resin molded article is not treated by etching by an acid containing chromium and/or manganese.

### DETAILED DESCRIPTION OF THE INVENTION

The plated resin molded article of the present invention can improve the productivity owing to good mold releasability when the injection molding method is applied as a method for manufacturing resin molded article before plating treatment. In addition, the plated resin molded article according to the present invention has a beautiful appearance even immediately after the plating and after the heat cycle test owing to high heat resistance and high adhesive strength to the plating.

<Resin Composition>

[(A) Component]

The synthetic resin of (A) component is preferably one, two or more resin of: (A-1) a resin having a water-absorption rate (ISO62) of 0.6% or more after 24 hours of immersion in water at 23° C.; and (A-2) a resin having a water-absorption rate (ISO62) of less than 0.6% after 24 hours of immersion at 23° C.

The resin of (A-1) component more preferably has water-absorption rate ranging from 0.6 to 11%, further preferably from 0.6 to 5%, and most preferably from 0.6 to 2.5%. The resin of (A-2) component more preferably has water-absorption rate of 0.4% or less.

According to the present invention, it is preferable to combine: one, two or more of the resins selected from (A-1) component and one, two or more of the resins selected from (A-2) component.

As for the resin of (A-1) component, preferred ones are polyamide-based resins, acrylate-based resins, cellulose-based resins, vinyl alcohol-based resins, and polyether-based resins, which satisfy the above saturated water absorption rate, more preferable ones are polyamide-based resins and polyether-based resins, and most preferable ones are polyamide-based resins.

Examples of the polyamide-based resins include: nylon 66, polyhexamethylene sebacamide (nylon 6•10), polyhexamethylene dodecanamide (nylon 6•12), polydodecamethylene dodecanamide (nylon 1212), polymethaxylylene adipamide (nylon MXD6), polytetramethylene adipamide (nylon 46), and mixtures or copolymers thereof; a copolymer such as nylon 6/66, nylon 66/6T (6T: polyhexamethyleneterephthalamide) containing 50% by mole or less of 6T component, nylon 66/6I (6I: polyhexamethylene isophthalamide) containing 50% by mole or less of 6I component, nylon 6T/6I/66 or nylon 6T/6I/610; and a copolymer such as polyhexamethylene terephthalamide (nylon 6T), polyhexamethylene isophthalamide (nylon 61), poly(2-methylpentamethylene)terephtalamide (nylon MST), poly(2-methylpentamethylene)isophthalamide (nylon M5I), nylon 6T/6I or nylon 6T/MST. Other than the above, a copolymerized nylon such as amorphous nylon can be used. The amorphous nylon includes a polycondensate of terephthalic acid with trimethylhexamethylene diamine.

Furthermore, there are applicable: ring-opening polymers of cyclic lactam; polycondensates of aminocarboxylate; copolymers of these components, specifically aliphatic polyamide resins such as nylon 6, poly-ω-dodecanamide (nylon 11), poly-ω-dodecanamide (nylon 12) or copolymers thereof; a copolymer with polyamide composed of diamine and dicarboxylic acid, specifically nylon 6T/6, nylon 6T/11, nylon 6T/12, nylon 6T/61/12, nylon 6T/61/610/12, and mixtures thereof.

Among these, preferred polyamide-based resins are PA(nylon)6, PA(nylon)66, and PA(nylon)6/66.

Examples of the resins of (A-2) component are the ones which satisfy the above saturated water absorption rate: an olefinic resin, a styrene-based resin, a polyphenylene ether resin, a polyester resin such as a polybutylene terephthalate resin or a polyethylene terephthalate resin; liquid crystalline polymer; thermoplastic resins such as a polyphenylene sulfide resin, a polyacetal resin or a polycarbonate resin; and thermosetting resins such as an epoxy resin, an unsaturated polyester resin or a phenol resin.

Olefinic resins are polymers having a C₂-C₈ mono-olefin as the main monomer component. Examples of the olefinic resins are one, two or more of those selected from low-density polyethylene, high-density polyethylene, linear low-density polyethylene, polypropylene, ethylene-propylene random block copolymer, ethylene-propylene block copolymer, polymethyl pentene, polybutene-1, and modified ones thereof. Among these, polypropylene is preferred.

Styrene-based resins include polymers of styrene, and polymers of styrene-derivatives such as α-substituted styrene or nuclei substituted styrene. There are also included copolymers composed of the above monomers as major components, and further monomers like vinyl compounds such as acrylonitrile, acrylic acid or methacrylic acid, and/or conjugated diene compounds such as butadiene or isoprene. For example, there include polystyrene, high-impact polystyrene (HIPS) resin, acrylonitrile-butadiene-styrene copolymer (ABS) resin, acrylonitrile-styrene copolymer (AS resin), styrene-methacrylate copolymer (MS resin), and styrene-butadiene copolymer (SBS resin).

As the polystyrene-based resins, there can be contained a styrene-based copolymer in which an unsaturated compound containing carboxyl group is copolymerized for improving the compatibility and reactivity with polyamide-based resin. The styrene-based copolymer in which an unsaturated compound containing carboxyl group is copolymerized, is a copolymer prepared by polymerizing an unsaturated compound containing carboxyl group and, if required, other monomer which can be copolymerized therewith, in the presence of a rubber-like polymer.

Examples of the components are:

(1) A graft polymer prepared by polymerizing a monomer containing an aromatic vinyl monomer as an essential component, or an aromatic vinyl with a monomer containing an unsaturated compound containing carboxyl group as an essential component, in the presence of a rubber-like polymer prepared by copolymerizing an unsaturated compound containing carboxyl group;

(2) A graft copolymer prepared by copolymerizing an aromatic vinyl with a monomer containing an unsaturated compound containing carboxyl group, as essential components, in the presence of a rubber-like polymer;

(3) A mixture of a rubber-reinforced styrene-based resin in which no unsaturated compound containing carboxyl group is copolymerized, and a copolymer of an unsaturated compound containing carboxyl group, with a monomer containing an aromatic vinyl as a essential component;

(4) A mixture of: above (1) and (2); and a copolymer containing an unsaturated compound containing carboxyl group and an aromatic vinyl, as essential components; and

(5) A mixture of: above (1) to (4); and a copolymer containing an aromatic vinyl as an essential component.

As for above (1) to (5), the aromatic vinyl is preferably styrene. The monomer copolymerizing with the aromatic vinyl is preferably acrylonitrile. The content of unsaturated compound containing carboxyl group in the styrene-based resin is preferably within the range of 0.1 to 8% by mass, and more preferably 0.2 to 7% by mass.

When the (A-1) component and the (A-2) component are used together as the (A) component of the present invention, the content of (A-1) component is preferably within the range of 10 to 90% by mass, more preferably 20 to 80% by mass, further more preferably 30 to 70% by mass, and most preferably 30 to 60% by mass. The content of (A-2) component is preferably within the range of 10 to 90% by mass, more preferably 20 to 80% by mass, furthermore preferably 30 to 70% by mass, and most preferably 40 to 70% by mass.

[(B) Component]

The water-soluble substance of (B) component has the solubility in water (at 25° C.) ranging from 0.01/100 g to 10 g/100 g.

Examples of the water-soluble substances of (B) components include the following compounds which satisfy the above solubility range: polysaccharides such as starch, dextrin, pollutant, hyaluronic acid, carboxymethyl cellulose, methyl cellulose, ethyl cellulose, or a salt thereof; polyvalent alcohols such as propylene glycol, ethylene glycol, diethylene glycol, neopentyl glycol, butane diol, pentane diol, polyoxyethylene glycol, polyoxypropylene glycol, trimethylol propane, pentaerythritol, dipentaerythritol or glycerin; polyvinyl alcohol, polyacrylic acid, polymaleic acid, polyacrylamide, polyvinyl pyrrolidone, polyethylene oxide, a copolymer of acrylic acid and maleic anhydride, a copolymer of maleic acid anhydride and di-isobutylene, a copolymer of maleic anhydride and vinyl acetate, a condensate of naphthalene sulfonate formalin, or a salt thereof.

As for the (B) component, pentaerythritol (solubility of 7.2 g/100 g) and dipentaerythritol (solubility of 0.22 g/100 g) are preferred.

The content of (B) component is within the range of 0.1 to 20 parts by mass to 100 parts by mass of the (A) component, preferably 0.1 to 10 parts by mass, and more preferably 0.5 to 5 parts by mass.

[(C) Component]

The polymer having a maleimide-based monomer unit as the (C) component is a component functioning as a compatibility agent. The polymer can also be added when a single synthetic resin is used as the (A) component. The polymer having a maleimide-based monomer unit as the (C) component may be that of maleimide-based monomer unit or may be a copolymer of the maleimide-based monomer with other monomer unit.

In the (C) component, the maleimide-based monomer as the maleimide-based monomer unit is preferably one, two or more compounds selected from maleimide, N-methylmaleimide, N-ethylmaleimide, N-propyl maleimide, N-isopropyl maleimide, N-cyclohexyl maleimide, N-phenyl maleimide, N-tolyl maleimide, N-xylyl maleimide, N-naphthyl maleimide, N-t-butyl maleimide, N-orthochlorophenyl maleimide, and N-orthomethoxyphenyl maleimide.

Examples of monomers as other monomer units are: aromatic vinyl-based compounds such as styrene, α-methyl styrene, vinyl ketone or t-butyl styrene; and unsaturated dicarboxylic anhydrides such as maleic anhydride, methylmaleic anhydride, 1,2-dimethyl maleic anhydride, ethyl maleic anhydride or phenyl maleic anhydride.

The (C) component is preferably a copolymer composed of a maleimide-based monomer, an aromatic vinyl monomer, and an unsaturated dicarboxylic anhydride monomer.

The content of the maleimide-based monomer unit in the (C) component is preferably within the range of 10 to 80% by mass, more preferably 30 to 60% by mass, and most preferably 40 to 55% by mass.

When the (C) component is a copolymer composed of a maleimide-based monomer, an aromatic vinyl monomer, and an unsaturated dicarboxylic anhydride monomer, the content of the maleimide-based monomer unit is preferably within the range of 10 to 80% by mass, more preferably 30 to 60% by mass, and further more preferably 40 to 55% by mass.

In the case of an aromatic vinyl-based compound unit, the content of the unit is preferably within the range of 10 to 80% by mass, more preferably 30 to 60% by mass, and further more preferably 40 to 55% by mass.

In the case of an unsaturated dicarboxylic anhydride unit, the content of the unit is preferably within the range of 0.1 to 10% by mass, more preferably 0.5 to 5% by mass, and further more preferably 0.5 to 3% by mass. If the content of the unsaturated dicarboxylic anhydride unit is 10% by mass or less, the flowability becomes better. If the content of the unsaturated dicarboxylic anhydride unit is 0.1% by mass or more, the impact strength becomes higher.

The content of (C) component is within the range of 1 to 40 parts by mass to 100 parts by mass of the (A) component, preferably 3 to 35 parts by mass, and more preferably 5 to 30 parts by mass.

[Other Components]

The resin composition used in the present invention can further contain a surfactant and/or a coagulant.

The surfactant may be one (emulsifier), used when emulsion polymerization is applied at the time of manufacturing (A) component, being left in the resin, or may be one which is added separately to the (A) component when a method such as bulk polymerization in which an emulsifier is not used, is applied.

The surfactant and the coagulant may be ones used in emulsion polymerization of resin, or may be ones except those used in emulsion polymerization of resins. The surfactant is preferably an anionic surfactant, a cationic surfactant, a nonionic surfactant, and an amphoteric surfactant.

Applicable surfactants include one, two or more surfactants selected from anionic surfactants such as fatty acid salt, rosinate, alkylsulfate, alkylbenzene sulfonate, alkyldiphenylether sulfonate, polyoxyethylene alkylether sulfonate, sulfosuccinate diester, α-olefin sulfate or α-olefin sulfonate; cationic surfactants such as mono- or di-alkylamine or a polyoxyethylene additive thereof, or mono- or di-long chain alkyl quaternary ammonium salt; nonionic surfactants such as alkyl glucoxide, polyoxyethylene alkylether, polyoxyethylene alkylphenylether, sucrose fatty acid ester, sorbitan fatty acid ester, polyoxyethylenesorbitan fatty acid ester, polyoxyethylene fatty acid ester, polyoxyethylene propylene block copolymer, fatty acid monoglyceride or amine oxide; and amphoteric surfactants such as carbobetain, sulfobetain or hydroxyl sulfobetain.

The content of surfactant in the resin composition is preferably within the range of 0.01 to 10 parts by mass to 100 parts by mass of the (A) component, more preferably 0.01 to 5 parts by mass, and further more preferably 0.01 to 2 parts by mass.

The resin composition used in the present invention can further contain one, two or more phosphorus-based compounds selected from:

condensate phosphoesters such as triphenyl phosphate, tricresyl phosphate, trixylenyl phosphate, tris(isopropylphenyl)phosphate, tris(o- or p-phenylphenyl)phosphate, trinaphthyl phosphate, cresyldiphenyl phosphate, xylenyldiphenyl phosphate, diphenyl(2-ethylhexyl)phosphate, di(isopropylphenyl)phenyl phosphate, o-phenylphenyldicresyl phosphate, tris(2,6-dimethylphenyl)phosphate, tetraphenyl-m-phenylene diphosphate, tetraphenyl-p-phenylene diphosphate, phenylresorcin-polyphosphate, bisphenol A-bis(diphenylphosphate), bisphenol A-polyphenyl phosphate, and dipyrocatecol hypodiphosphate;

fatty acid-aromatic phosphoesters such as orthophosphates including diphenyl(2-ethylhexyl)phosphate, diphenyl-2-acryloyloxyethyl phosphate, diphenyl-2-methacryloyloxyethyl phosphate, diphenyl neopentyl phosphate, pentaerythritol diphenyl diphosphate, ethylpyrocatechol phosphate, and the like; and

alkali metal salts of melamine polyphosphate, tripolyphosphoric acid, pyrophosphoric acid, orthophosphoric acid, hexamethaphosphoric acid, and the like, a phosphoric acid-based compound such as phytic acid, alkali metal salts thereof, or alkanol amine salts thereof.

Furthermore, as phosphorus-based compounds other than the above, there can be applied phosphorus-based compounds which are used as known fire retardants and antioxidants for resins.

The content of the phosphorus-based compound in the resin composition is preferably within the range of 0.1 to 30 parts by mass to 100 parts by mass of the (A) component, more preferably 0.1 to 20 parts by mass, and further more preferably 0.1 to 10 parts by mass.

The resin composition used in the present invention can further contain inorganic fillers. Applicable inorganic fillers include granular or powdered filler, and fibrous filler. The inorganic fillers are components for improving the mold-releasability when resin molded article intended for plating is injection-molded, but are not components for functioning so as to increase the plating adhesive strength after plating.

Examples of the granular or powdered fillers are, talc, carbon black, graphite, titanium dioxide, silica, mica, calcium sulfate, calcium carbonate (heavy calcium carbonate and precipitated calcium carbonate), barium carbonate, magnesium carbonate, magnesium sulfate, barium sulfate, oxysulfate, tin oxide, alumina, kaolin, silicon carbide, metal powder, glass powder, glass flake, and glass bead.

The granular or powdered filler has preferably a mean particle size of 100 μm or smaller, more preferably 50 μm or smaller, further more preferably 10 μm or smaller, and most preferably 5 μm or smaller. By adjusting the mean particle size of the granular or powdered filler within the above range, the mold releasability at the time of injection molding can be improved, and the appearance after plating can be brought to a beautiful one. The mean particle size, expressed by the 50% particle size median value, is determined by the sedimentation balance method.

Examples of the fibrous fillers can include wollastonite, glass fiber, milled glass fiber, carbon fiber, milled carbon fiber, potassium titanate whisker, aluminum borate whisker, zinc oxide whisker, and attapulgite.

The fibrous filler is preferably wollastonite. The granular or powdered filler is preferably talc, calcium carbonate (specifically precipitated calcium carbonate having a small mean particle size), kaolin, and the like. When calcium carbonate is used, the mean particle size thereof is preferably 2 μm or smaller, and more preferably 1.5 μm or smaller, 1.0 μm or smaller, 0.5 μm or smaller, and 0.1 μm or smaller.

The content of the inorganic filler is within the range of 1 to 55 parts by mass to 100 parts by mass of the sum of (A), (B), and (C) components, preferably 1 to 40 parts by mass, more preferably 1 to 35 parts by mass, and most preferably from 5 to 25 parts by mass. By adjusting the content of the inorganic filler within the above range, the mold releasability at the time of injection molding can be improved, and the appearance after plating can be brought to a beautiful one.

The resin composition of the present invention can contain various known additives depending on the use of the resin molded article.

<Plated Resin Molded Article>

The plated resin molded article according to the present invention is prepared by using the above resin composition, by applying a known molding method such as injection molding or extrusion molding to obtain a resin molded article having a desired shape depending on the intended use, and then by plating in the following-described process. The plated resin molded article of the present invention, however, is obtained without applying etching treatment of the resin molded article intended for plating, by an acid containing chromium and/or manganese in the plating process.

The applicable plating method may be any if only the method can form a metallic layer or a metallic film on the surface of the resin molded article, and wet plating using a plating bath, and dry plating of physical vapor deposition (PVD), chemical vapor deposition (CVD), and the like, can be applied. Applicable wet plating methods are (I) the one given in Examples described in JP-A 2003-82138, JP-A 2003-166067 and JP-A 2004-2996A, (a method containing electroless plating process), and (II) the one containing direct plating process. For both plating methods, the surface of the resin molded article intended for plating is not treated by etching by an acid containing chromium and/or manganese.

(I) The method given in Examples described in JP-A 2003-82138, JP-A 2003-166067 and JP-A 2004-2996, (a plating method containing electroless plating process)

(1) Degreasing process

(2) Acid contact treatment process

(3) Catalyst addition process

(4) First activation process

(5) Second activation process

(6) Nickel electroless plating process

(7) Acid activation process

(8) Copper electroplating process

(II) Plating method containing direct plating process

(1) Degreasing process

(2) Acid contact treatment process (Etching process)

(3) Catalyst addition process

(4) Direct plating process

(5) Copper electroplating process In the plating method (II), the degreasing process, the acid contact treatment process, the catalyst providing process, and the copper electroplating process are the same to those described in Examples of JP-A 2003-82138, JP-A 2003-166067 and JP-A 2004-2996. However, the “(2) acid contact treatment process” in the plating method (II) adopts a higher concentration of acid than that in the “(2) acid contact treatment process” in the plating method (I).

As the acid in the “(2) acid contact treatment process” in the plating method (II), hydrochloric acid, phosphoric acid, sulfuric acid, and further organic acids selected from acetic acid, citric acid, formic acid, and the like can be used.

For hydrochloric acid, the normality is preferably from 1.5 to 3.5, more preferably from 1.8 to 3.5, and further more preferably from 2 to 3.

The treatment in the process can apply, for example, a method of immersing resin molded article into an acid, such as immersing it into an acid for 0.5 to 20 minutes at 10° C. to 80° C. When the hydrochloric acid normality of 1.5 to 3.5 is used, an applicable method is to immerse it into an aqueous solution of hydrochloric acid within the above concentration range for 1 to 10 minutes at 20° C. to 60° C.

The plating method (II) containing direct plating process is known, which is disclosed in JP-A 05-239660, WO98/45505 (Japanese Patent No. 3208410), JP-A 2002-338636 (Paragraph 5), and the like.

In the direct plating process, a plating liquid containing a metallic compound called selector liquor, a reducing compound, and a metallic hydroxide are used and a very thin conductive layer is formed compared with the thickness of the plating layer (conductive layer) created by chemical plating commonly used.

The metallic compounds include preferably copper compounds, such as copper sulfate, copper chloride, copper carbonate, copper oxide or copper hydroxide. The content of the copper compound is preferably within the range of 0.1 to 5 g/L as copper, and more preferably 0.8 to 1.2 g/L.

The reducing compounds do not include the ones having strong reducing power, such as formalin or phosphinic acid, which are commonly used in known electroless plating (chemical plating). The applied reducing compound has weak reducing power compared with the ones given above. Examples of applicable reducing compounds include:

mercury(II) chloride, sodium borohydride, dimethylamine borane, trimethylamine borane, formic acid or salts thereof, and alcohols or salts thereof, such as methanol, ethanol, propanol, ethylene glycol or glycerin.

Reducing saccharides include glucose, sorbit, cellulose, sucrose, mannit, and gluconolactone. The content of saccharides is preferably within the range of 3 to 50 g/L, and more preferably 10 to 20 g/L.

Applicable metallic hydroxides include sodium hydroxide, potassium hydroxide, and lithium hydroxide. The content of metallic hydroxide is preferably within the range of 10 to 80 g/L, and more preferably 30 to 50 g/L.

The selector liquor can contain a complexing agent, if required. The applicable complexing agents include hydantoins and organic carboxylic acids. The hydantoins include hydantoin, 1-methyl hydantoin, 1,3-dimethyl hydantoin, 5,5-dimethyl hydantoin, and allantoin. The organic carboxylic acid group includes citric acid, tartaric acid, succinic acid, and salts thereof. The content of the complexing agent in the selector liquor is preferably within the range of 2 to 50 g/L, and more preferably 10 to 40 g/L.

The pH of selector liquor is preferably within the range of 10.0 to 14.0, and more preferably 11.5 to 13.5.

Examples of the selector liquors are the plating bath described in Example 1 (c) (paragraph 31) of JP-A 5-239660, and the baths 1 to 8 of the invention, described in Examples of WO 98/45505 (Japanese Patent No. 3208410). Other known component can be added, if required.

The treatment in the direct plating process can apply a method of adjusting the temperature of the selector liquor within the range preferably of 20° C. to 70° C., and more preferably 35° C. to 50° C., and then immersing the resin molded article in the selector liquor for about 30 seconds to 20 minutes, preferably for about 3 to 5 minutes.

The treatment of direct plating process forms a very thin conductive layer on the surface of the resin molded article, which allows direct electroplating in the succeeding process.

The plated resin molded article according to the present invention is preferably the one giving no change in appearance by visual observation after the following heat cycle test.

(Heat Cycle Test 1)

A plated resin molded article (100 mm in length, 50 mm in width, and 3 mm in thickness) as a test piece is subjected to total three cycles of heat cycle test: a single cycle being composed of holding the test piece for 60 minutes at −30° C., at 90° C. for 60 minutes, and then for 30 minutes at room temperature (20° C.)

(Heat Cycle Test 2)

A plated resin molded article (100 mm in length, 50 mm in width, and 3 mm in thickness) as a test piece is subjected to total three cycles of heat cycle test: a single cycle being composed of holding the test piece for 60 minutes at −30° C., for 30 minutes at room temperature (20° C.), for 60 minutes at 100° C., and then for 30 minutes at room temperature (20° C.)

The shape of the plated resin molded article, the kind and thickness of plating layer, and the like according to the present invention can be adequately selected depending on the use, and can be applied in varieties of uses. The plated resin molded article according to the present invention is suitable for: automobile parts including outer parts such as bumper, emblem, wheel cap or radiator grill, and inner parts such as steering wheel; parts for motorcycles; buttons of household electric appliances and cell phones; knobs and nameplate of household electric appliances; tap water and shower parts.

### EXAMPLES

### Resin Composition

(A) component

(A-1-1): Polyamide (Polyamide 6, UBE nylon 61013B, water absorption rate 1.8%, manufactured by Ube Industries, Ltd.)

(A-2-1): ABS resin (styrene 45% by mass, acrylonitrile 15% by mass, rubber 40% by mass)

(B) component

(B-1): Dipentaerythritol (manufactured by Koei Chemical Co., Ltd.)

(C) component

(C-1) Copolymer of styrene —N-phenylmaleimide-maleic anhydride, (styrene 47% by mass, N-phenylmaleimide 51% by mass, and maleic anhydride 2% by mass, a weight-average molecular weight 145,000)

(Other Components)

Maleic anhydride modified ABS (maleic anhydride 4% by mass, styrene 43% by mass, acrylonitrile 15% by mass, rubber 38% by mass)

Wollastonite (KAP-170, mean particle size 6.8, manufactured by Kansai Matec Co., Ltd.)

Calcium carbonate (Calfine 200, mean particle size 0.07 manufactured by Maruo Calcium Co., Ltd.)

(Measurement Method)

Charpy impact strength: Determined in accordance with ISO 179.

HDT: Determined under load of 1.80 MPa, in accordance with ISO 75.

Adhesive strength: The adhesive strength (maximum value) between the resin molded article and the metallic plating layer was determined using the plated resin molded articles prepared by Examples and Comparative Examples by the adhesion test method described in Annex 6 of JIS H8630.

Heat Cycle Test

(Heat Cycle Test 1)

A plated resin molded article (100 mm in length, 50 mm in width, and 3 mm in thickness) as a test piece was subjected to total three cycles of heat cycle test: a single cycle being composed of holding the test piece for 60 minutes at −30° C., for 30 minutes at room temperature (20° C.), for 60 minutes at 100° C., and then for 30 minutes at room temperature (20° C.).

(Heat Cycle Test 2)

A plated resin molded article (100 mm in length, 50 mm in width, and 3 mm in thickness) as a test piece was subjected to total three cycles of heat cycle test: a single cycle being composed of holding the test piece for 60 minutes at −30° C., for 30 minutes at room temperature (20° C.), for 60 minutes at 110° C., and then for 30 minutes at room temperature (20° C.).

### Examples and Comparative Examples

The respective components listed in Table 1 were blended in a V-shape tumbler, and were then melted and kneaded in a twin-screw extruder (TEX30, cylinder temperature 230° C., rotational speed 350 ppm, manufactured by The Japan Steel Works, Ltd.), changing the extrusion rate, thus pellets being obtained. The pellets were fed to an injection molding machine (cylinder temperature 240° C., mold temperature 60° C.) to manufacture resin molded articles (100 mm×50 mm×3 mm).

Thus obtained resin molded articles were used as test pieces, which were then subjected to (I) plating having electroless plating process, and (II) plating having direct plating process, and the respective plated resin molded articles were manufactured. The results of heat cycle test for these plated resin molded articles are given in Table 1.

(I) Plating Having Electroless Plating Process

(1) Degreasing Process

The test piece was immersed into an aqueous solution (40° C. of liquid temperature) of 50 g/L of ACE CLEAN A-220, (manufactured by Okuno Chemical Industries, Ltd.) for 20 minutes.

(2) Acid Contact Treatment Process

The test piece was immersed into 100 ml of hydrochloric acid (40° C. of liquid temperature) having a normality of 1.0 for 5 minutes.

(3) Catalyst Addition Process

The test piece was immersed into a mixed aqueous solution (25° C. of liquid temperature) of 150 ml/L of 35% by mass of hydrochloric acid and an aqueous solution of 40 ml/L of CATALYST C (Okuno Chemical Industries, Ltd.) for 3 minutes.

(4) First Activation Process

The test piece was immersed into an aqueous solution (40° C. of liquid temperature) of 100 ml/L of 98% by mass of sulfuric acid for 3 minutes.

(5) Second Activation Process

The test piece was immersed into an aqueous solution (40° C. of liquid temperature) of 15 g/L of sodium hydroxide for 2 minutes.

(6) Nickel Electroless Plating Process

The test piece was immersed into a mixed aqueous solution (40° C. of liquid temperature) of 150 ml/L of electroless nickel HR-TA (manufactured by Okuno Chemical Industries, Ltd.) and 150 ml/L of electroless nickel HR-TB (manufactured by Okuno Chemical Industries, Ltd.) for 5 minutes.

(7) Acid Activation Process

The test piece was immersed into an aqueous solution (25° C. of liquid temperature) of 100 g/L of TOP SAN (manufactured by Okuno Chemical Industries, Ltd.) for 1 minute.

(8) Copper Electroplating Process

The test piece was immersed into the same plating bath (25° C. of liquid temperature) as that in Example 1, and electroplating was conducted for 120 minutes.

(II) Plating Having Direct Plating Process

(1) Degreasing Process

The resin molded article was immersed into an aqueous solution (40° C. of liquid temperature) of 50 g/L of Ace CLEAN A-220, (manufactured by Okuno Chemical Industries Co., Ltd.) for 5 minutes.

(2) Etching Process (Acid Contact Treatment Process)

The resin molded article was immersed into an aqueous solution (40° C. of liquid temperature) of 200 ml/L (normality of 2.3) of 35% by mass of hydrochloric acid for 5 minutes.

(3) Catalyst Addition Process

The resin molded article was immersed into a mixed aqueous solution (25° C. of liquid temperature) of 150 ml/L of 35% by mass of hydrochloric acid and an aqueous solution of 40 ml/L of CATALYST C (Okuno Chemical Industries, Ltd.) for 3 minutes.

(4) Direct Plating Process

The resin molded article was immersed into a selector liquor (temperature 45° C., pH 12) having the following composition for 3 minutes to form a conductive layer on the surface of the resin molded article.

| | |
|---|---|
| Copper sulfate | 3 g/L |
| Sodium hydroxide | 30 g/L |
| Glucose | 10 g/L |
| Hydantoin | 10 g/L |

(5) Copper Electroplating Process

The resin molded article was immersed into a plating bath (25° C. of liquid temperature) having the following composition to perform electroplating for 120 minutes.

(Composition of plating bath)

| | | |
|---|---|---|
| Copper sulfate (CuSO₄•5H₂O) | 200 | g/L |
| Sulfuric acid (98%) | 50 | g/L |
| Chlorine ion (Cl⁻) | 5 | ml/L |
| TOP LUCINA 2000MU (manufactured by Okuno Chemical | 5 | ml/L |
| Industries, Ltd.) | | |

After the copper plating, visual observation was given to evaluate the appearance immediately after the plating. The plated resin molded article having obtained smooth surface was obtained was evaluated as being good, and that of rough surface was evaluated as being bad. The bad plated resin molded article was not subjected to heat cycle test.

The good evaluation results in the heat cycle test given in Table 1 signify the case where no change or little change in the appearance was confirmed by visual observation, between immediately after the plating and after the heat cycle test, while the term “Blistering” indicates that the visual observation identified separation of plating layer from the resin molded article in a part.

TABLE 1

| | Examples | | | | | | | | | | |
|---|---|---|---|---|---|---|---|---|---|---|---|
| | 1 | 2 | 3 | 4 | 5 | 6 | 7 | 8 | 9 | 10 | 11 |
| (A-1-1) Polyamide | 60 | 60 | 50 | 50 | 70 | 70 | 70 | 60 | 60 | 60 | 60 |
| (A-2-2) ABS resin | 25 | 25 | 40 | 30 | 20 | 20 | 20 | 20 | 20 | 20 | 25 |
| (B-1) Dipentaerythritol | 1 | 1 | 1 | 1 | 1 | 1 | 1 | 1 | 1 | 1 | 1 |
| (C-1) | 15 | 15 | 10 | 20 | 10 | 10 | 10 | 20 | 20 | 20 | 15 |
| Acid modified ABS | | | | | | | | | | | |
| Wollastonite | | | 20 | | 30 | 30 | 20 | | | | |
| Calcium carbonate | | | | | | | | | 20 | 20 | |
| Manufacturing condition | 10 | 10 | 10 | 10 | 10 | 10 | 10 | 10 | 10 | 10 | 20 |
| (Injection rate kg/h) | | | | | | | | | | | |
| (Plating method) | Electroless | DP | Electroless | Electroless | Electroless | DP | Electroless | Electroless | Electroless | DP | Electroless |
| Electroless: electroless plating | | | | | | | | | | | |
| DP: Direct plating | | | | | | | | | | | |
| Appearance immediately after | Good | Good | Normal | Good | Normal | Normal | Normal | Good | Good | Good | Good |
| the plating | | | | | | | | | | | |
| HDT (1.8 MPa) | 68 | 68 | 88 | 65 | 111 | 111 | 100 | 73 | 77 | 77 | 68 |
| HDT (0.45 MPa) | 128 | 128 | 125 | 105 | 187 | 187 | 150 | 132 | 135 | 135 | 128 |
| Charpy impact strength | 15 | 15 | 5 | 10 | 3 | 3 | 5 | 10 | 8 | 8 | 10 |
| Adhesive strength | 1 | 0.8 | 1.1 | 1.1 | 1.3 | 1 | 1.1 | 0.9 | 1.1 | 0.9 | 0.5 |
| Heat cycle test 1 (−30/100) | OK | OK | OK | OK | OK | OK | OK | OK | OK | OK | OK |
| Heat cycle test 2 (−30/110) | NG | NG | OK | NG | OK | OK | OK | NG | NG | NG | NG |

| | Comparative Examples | | | | |
|---|---|---|---|---|---|
| | 1 | 2 | 3 | 4 | 5 |
| (A-1-1) Polyamide | | 50 | 50 | 50 | 60 |
| (A-2-2) ABS resin | 100 | 40 | 40 | 40 | 25 |
| (B-1) Dipentaerythritol | 1 | | | | |
| (C-1) | | | | | |
| Acid modified ABS | | 10 | 10 | 10 | 15 |
| Wollastonite | 40 | 20 | | | |
| Calcium carbonate | | | | | |
| Manufacturing condition | 10 | 10 | 10 | 10 | 10 |
| (Injection rate kg/h) | | | | | |
| (Plating method) | Etectroless | Electroless | Electroless | DP | Electroless |
| Electroless: electroless plat | | | | | |
| Appearance immediately after | Bad | Good | Good | Good | Good |
| the plating | | | | | |
| HDT (1.8 MPa) | 80 | 80 | 66 | 66 | 55 |
| HDT (0.45 MPa) | 93 | 104 | 95 | 95 | 100 |
| Charpy impact strength | 40 | 4 | 68 | 68 | 65 |
| Adhesive strength | 0.1 | 1.2 | 0.9 | 0.5 | 1.1 |
| Heat cycle test 1 (−30/100) | — | NG | NG | NG | NG |
| Heat cycle test 2 (−30/110) | — | NG | NG | NG | NG |

1. A plated resin molded article comprising:
a resin molded article having a metallic plating layer on the surface thereof, composed of a resin composition comprising (A) a synthetic resin, (B) a water-soluble substance having a solubility in water (at 25° C.) ranging from 0.01/100 g to 10 g/100 g, and (C) a polymer having a maleimide-based monomer unit, provided that the resin molded article is not treated by etching with an acid containing chromium and/or manganese.

2. The plated resin molded article according to claim 1, wherein the synthetic resin of (A) component comprises: (A-1) 10 to 90% by mass of a resin having a water-absorption rate (ISO62) of 0.6% or more after 24 hours of immersion in water at 23° C.; and (A-2) 10 to 90% by mass of a resin having a water-absorption rate (ISO62) of less than 0.6% after 24 hours of immersion in water at 23° C.

3. The plated resin molded article according to claim 1, wherein the maleimide-based monomer of (C) component is a compound selected from the group consisting of maleimide, N-methylmaleimide, N-ethylmaleimide, N-propyl maleimide, N-isopropyl maleimide, N-cyclohexyl maleimide, N-phenyl maleimide, N-tolyl maleimide, N-xylyl maleimide, N-naphthyl maleimide, N-t-butyl maleimide, N-orthochlorophenyl maleimide, and N-orthomethoxyphenyl maleimide.

4. The plated resin molded article according to claim 1, wherein change in appearance thereof by visual observation is not detected after the following heat cycle test:
(Heat cycle test 1)
Heat cycle test comprises three cycles, each cycle being conducted, using a test piece of plated resin molded article having 100 mm in length, 50 mm in width, and 3 mm in thickness, by holding the test piece for 60 minutes at −30° C., by holding the test piece for 30 minutes at room temperature (20° C.), by holding the test piece for 60 minutes at 100° C., and then by holding the test piece for 30 minutes at room temperature (20° C.).

5. A method for manufacturing plated resin molded article having a metallic plating layer, comprising step of applying a metallic plating on the surface of a resin molded article composed of a resin composition comprising (A) a synthetic resin, (B) a water-soluble substance having a solubility in water (at 25° C.) ranging from 0.01/100 g to 10 g/100 g, and (C) a polymer having a maleimide-based monomer unit, provided that the resin molded article is not treated by etching by an acid containing chromium and/or manganese.
